(19) United States
(12) Patent Application Publication
(10) Pub. No.: US 2006/0239548 A1
(43) Pub. Date: Oct. 26, 2006

(54) Segmentation of digital images

(76) Inventors: William Frederick George Gallafent, Oxford (GB); Francis Pratt, Castelnau-de-montmiral (FR); Alistair Imeson Watson, Dublane (GB)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/071,065

(22) Filed: Mar. 3, 2005

(51) Int. Cl. G06K 9/34

(52) U.S. Cl. 382/164; 382/173

(57) ABSTRACT

An apparatus and method for segmenting a digital image into image segments includes selecting one or more pixels in an image to define an initial pixel selection, determining a final pixel selection which includes those pixels in the image that are contiguous with the initial pixel selection and that have sets of n values corresponding to points in an n-dimensional space in the same characteristic segments as those points corresponding to the sets of n values of pixels in the initial selection. The pixel values of the final pixel selection are assigned to a first image segment such that the visual characteristics of the pixels of the first image segment may be modified independently of other pixels.

### FIELD OF THE INVENTION

The present invention relates to the manipulation of digital images, and particularly to the segmentation of digital images into segments.

### BACKGROUND OF THE INVENTION

A digital image is an image that is stored as digital data rather than as an image formed on a photographic film which has traditionally been the case. The use of digital images is becoming increasingly common in the fields of still and moving images such as photography and cinema since digital images can be manipulated, modified, combined and stored far more easily than traditional photographic film based images and many techniques have been developed to provide for a wide variety of image processing.

In one kind of digital image, known as a bitmap, an image is separated into an array of small regions, usually square or rectangular in shape, known as pixels. For example, a typical bitmap image may be formed of an array of 1024 pixels by 512 pixels. The array of pixels forming a digital image may be referred to as forming an image space. Each pixel has one or more values associated with it which define the visual characteristics, or visual parameters, of the pixels. For example a pixel may have one or more values which define the colour of the pixel. A pixel may have other values associated with it which define other characteristics such as the texture of the image at the pixel or the image variability at the pixel. In these last two cases, the value associated with a particular pixel depends not only on the visual characteristics of that pixel, but also the visual characteristics of pixels in the vicinity of that pixel.

The colour of a pixel is commonly defined by three values which are the values of three colour components, or parameters, that make up the colour. For example, in one system known as the RGB system, colour is created by adding together specific amounts of the three primary colours, red, green, and blue which are the three colour components in this system. A pixel colour is then defined by specifying the amounts of the three primary colours that are present within the colour. In some electronic display systems each colour component has a value which is an integer within the range of 0 to 255. With three colour components this gives 256³≈16.78 million possible colours.

Other common colour systems include a subtractive system based on the three colours Cyan, Yellow and Magenta often used in printing, the HLS system based on Hue, Lightness and Saturation and the international standard known as CIE. Other colour systems are known to those skilled in the art including systems that use greater or fewer than three colour components, one example being a greyscale in which a ‘colour’ is defined by a single intensity or lightness value.

In some cases, it may be convenient to group visual parameters together. For example, in each of the above colour systems, the three colour components may be grouped together for convenience since colour is usually thought of as being a single visual characteristic. However, in other cases, each colour component or any other visual parameter may be regarded as representing a visual characteristic in its own right. For example, in the HLS system, the hue of a pixel may be considered to be an individual visual characteristic.

The set of all possible colours may be considered to form a space, referred to here as a colour space, in which each point in the colour space represents a particular colour. The number of dimensions of the colour space is equal to the number of colour components used to define a colour and the co-ordinates of a point in the colour space are the values of the components of the colour represented by the point. For example, using the HLS system, a three dimensional colour space may be defined so that the three co-ordinates of a point in the colour space give the hue, lightness and saturation values for the colour represented by that point. If additional visual parameters are used such as texture parameters, then the colour space may be extended to include extra dimensions corresponding to the additional parameters. The additional co-ordinates associated with the extra dimensions of a point in the extended space give the values of the additional parameters. In general, if the visual characteristics of each pixel are defined by the values of n parameters, then an n-dimensional space may be defined in which the n co-ordinates of a point are the particular combination of n values determining the visual characteristic represented by that point.

A digital image is typically displayed using an apparatus including a display such as a monitor connected to a computer comprising a processor. The digital image data comprising information describing the visual characteristics of each pixel together with their location within the image is used by the display to display the complete image. The apparatus may provide means to allow a user to manipulate the digital image including input devices such as a keyboard or a mouse together with a user interface allowing the user to select and modify various portions of the image or perform any other desired operation.

One common process to manipulate digital images is selecting one or more pixels of an image and modifying the characteristics of those pixels, such as changing their colour, texture or hue for example. In one particular example, it may be desirable to manipulate an image comprising a foreground portion and a background portion by modifying the visual characteristics of either the foreground portion or the background portion only. For example, in an image of a boat sailing in the sea it may be desired to modify the tint of the water forming the background while leaving the boat in the foreground unchanged. In another example, it may be desirable to cut out the foreground portion of an image such as a person standing in front of a building, and overlay that foreground onto a different background such as a beach scene. In another more general example, it may be desirable to modify different parts of an image in different ways so that for example, the hue of a first portion, the lightness of a second portion and the texture of a third portion of an image are modified.

In the above examples, it is necessary to separate the image into distinguishable portions so that the visual characteristics of individual portions can be modified independently of the visual characteristics of the other portions. For example where the visual characteristics of the background only need to be modified, it is necessary to separate the image into a background portion and a foreground portion, each portion comprising a specific group of pixels. Separating the pixels of an image into groups for the purpose of modifying the characteristics of only some of the groups of pixels may be referred to as segmenting an image and each specific group of pixels may be referred to as an image segment. A particular pixel belonging to a particular image segment may be said to be assigned to that image segment.

The segmentation of an image may be made manually by a user by selecting individual pixels or groups of pixels in an image. However, this process is extremely labour intensive and time consuming, especially when the number of pixels in the image is large, as is usually the case.

There are a number of alternative methods for segmenting images. For example, one method uses the colour of pixels to distinguish between the background and foreground portions of an image. According to the method, any pixel in the image whose colour is one of a predetermined set of colours is considered to belong to the background. The colour of each pixel in the image is determined and a pixel is assigned to a background image segment if the colour of the pixel is one of the predetermined set of colours. All pixels not assigned to the background image segment are assigned to a foreground image segment.

This technique is used in the creation of special effects in photography or cinema where for example an image of a person in front of a blue screen is made. Then, any blue pixels in the image will be assigned to the background segment allowing any desired background to be added. One problem with this technique is that it is necessary to ensure that the colours of the background are not present in the foreground otherwise pixels of the foreground will be wrongly assigned to the background segment. Another problem with this method is that it is artificial in nature, requiring a specially prepared image in which the background contains a set of predetermined colours. Therefore, the method is limited when applied to general images.

There are other problems with prior techniques for segmenting an image. For example, it may be difficult in some cases to precisely define the image segments. For example, the colours or other visual characteristics on the two sides of a border between a foreground object and its background may be very similar, as often happens in deeply shaded regions. In this case it may be difficult to precisely define foreground and background image segments according to colour or other visual characteristics. In a second example, where an edge is soft or blurred such as with hair against a background it may be difficult to define the boundary between the desired foreground and background image segments. Other examples where difficulties can occur are where the edges of the objects are complex, creating promontories and small separated regions, such as with leaves against the sky, or where an object is very thin such as in the case of individual hairs or blades of grass.

When difficulties such as those described above occur, prior techniques often assign pixels to the wrong image segment, for example assigning a background pixel to the foreground image segment resulting in the visual characteristics of some pixels being wrongly modified.

We have appreciated the need for a method for segmenting an image which does not require specially prepared images and which may be applied to general images. We have also appreciated the need for a method of segmenting an image in which the number of wrongly assigned pixels is minimised. We have further appreciated the need for a method for segmenting an image in which the segmentation can be adjusted and refined in an efficient and straightforward manner so that the number of wrongly assigned pixel is reduced further.

### SUMMARY OF THE INVENTION

The invention is defined in the independent claims to which reference may now be made. Preferred features are set out in the dependent claims.

In one exemplary embodiment of the invention, a digital image is segmented to define foreground and background image segments. A user manually selects pixels in a region of the image which is to be defined as the foreground image segment to obtain an initial pixel selection. The colours of the pixels in the initial pixel selection form a set of colours referred to as an initial colour selection. The initial colour selection is representative of the colours present in the foreground of the image. However, some colours in the foreground of the image are likely to be absent from the initial colour selection. To rectify this, the initial colour selection is automatically expanded so as to produce a final colour selection comprising a more complete set of colours reflecting the colours present in the foreground. In one embodiment this is achieved by segmenting colour space into several contiguous colour segments using any suitable algorithm. Then, all colours in those colour segments containing colours in the initial colour selection are added to the initial colour selection to form the final colour selection. All pixels in the image having a colour present in the final colour selection, and that are contiguous with the initial pixel selection are assigned to the foreground image segment. All other pixels in the image are assigned to the background image segment.

A refinement process may then be carried out to refine the segmentation of the image. In the above process a final colour selection is produced which is representative of the colours present in the foreground of the image. The colours in the final colour selection may therefore be thought of as being assigned to the foreground image segment. All the other colours in the image may be thought of as being assigned to the background image segment. To refine the image segmentation the user selects a region of the image in which pixels have been assigned to the wrong image segment to produce a refinement pixel selection. This may be the case at the boundary between the foreground and background of the image. The colours present in the refinement pixel selection form a set of colours, or refinement colour selection, containing colours which may need to be reassigned to a different image segment. The colours in the refinement colour selection are then displayed to a user in a user interface in the form of a tree structure. The user may navigate through the tree structure to select and reassign colours to different image segments. Selection of colours is aided by the fact that only those colours in the image that require detailed attention are displayed. The tree structure advantageously allows the user to select and modify the assignment of both groups of colours or individual colours.

### BRIEF DESCRIPTION OF THE FIGURES

FIG. 1 shows a digital image comprising a foreground portion and a background portion;

FIG. 2 is a schematic diagram of a system embodying the invention;

FIG. 3 is a flow diagram of the steps taken to segment an image according to a first aspect of the invention;

FIG. 4 shows the colour space of the digital image shown in FIG. 1 that has been segmented into several colour segments;

FIG. 5 shows an initial pixel selection in the digital image shown in FIG. 1 and the corresponding initial colour selection in the colour space shown in FIG. 4;

FIG. 6 shows a final colour selection in the colour space shown in FIG. 4 and the corresponding intermediate pixel selection in the digital image shown in FIG. 1;

FIG. 7 shows a final pixel selection in the digital image shown in FIG. 1;

FIG. 8 is a flow diagram of the steps taken to refine the segmentation of an image according to a second aspect of the invention;

FIG. 9 shows a first view of a first user interface for refining the segmentation of an image;

FIG. 10 shows a second view of the first user interface shown in FIG. 9;

FIG. 11 shows a third view of the first user interface shown in FIG. 9;

FIG. 12 shows a second user interface for refining the segmentation of an image;

FIG. 13 shows a third user interface for refining the segmentation of an image.

### DETAILED DESCRIPTION OF PREFERRED EMBODIMENTS

The present invention provides a method for segmenting a digital bitmap image comprising an array of pixels. Segmenting an image means separating the pixels that make up the image into two or more groups, each group of pixels forming an image segment. A segment is thus a defined region of an image produced as a result of the segmentation process. Segmentation is performed to allow the visual characteristics of pixels in one image segment to be modified independently of the pixels in other image segments. Each pixel in the image has one or more values associated with it defining the visual characteristics of each pixel. Examples of visual characteristics include colour, texture, opacity and transparency although the present invention is not limited to these specific examples. In general, the present invention may be applied whenever the visual characteristic of pixels are defined by at least one value associated with each pixel.

The invention resides in two aspects: First, a process for segmenting an image based on an initial selection, and second, a refinement to the segmentation.

In the exemplary implementations described below, each pixel has three values associated with it which are the Hue, Saturation, Lightness values defining the colour of the pixel using the HSL system described above. In other implementations, each pixel may have one or more additional values defining for example a texture characteristic. It is understood that any other additional or alternative number and combination of visual parameters could be used. In the example described below a digital image comprising a foreground portion and a background portion is segmented to generate three image segments which will be referred to as the foreground image segment 23, the background image segment 25 and the edge image segment 27. The edge image segment 27 is comprised of pixels that form the boundary between the background and foreground portions of the image and may be used to provide blending between the foreground and a new background using the method described in our United Kingdom patent application published as GB 2,405,067. It is understood that an image may be segmented into any number of segments and it is not necessary that the segmentation is performed on the basis of background and foreground portions of an image.

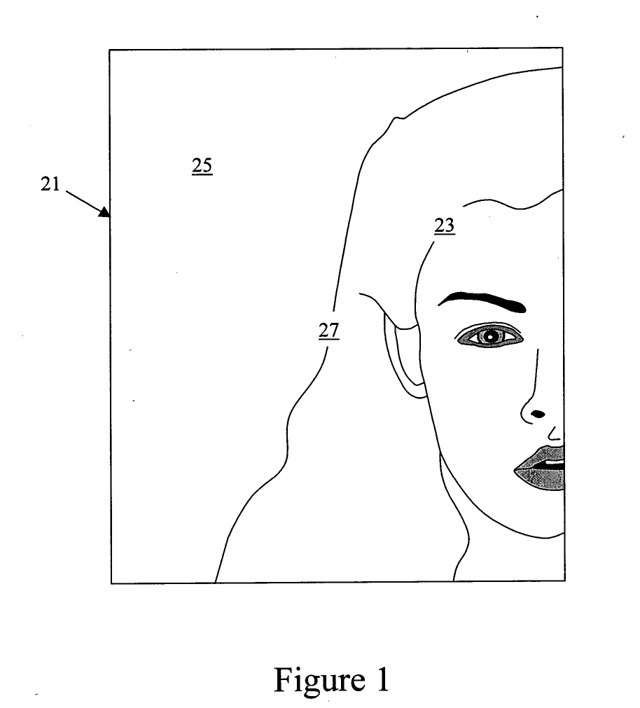

FIG. 1 shows a portion of a digital image 21 having a foreground portion comprising a face and hair and a background portion. References below to foreground and background when these terms are used alone refer to the foreground portion and the background portion of the image 21. A particular feature of this image that causes difficulties for prior methods is the boundary between the hair and the background. Following segmentation of the image 21, the visual characteristics of an individual image segment, such as the background image segment 25, may be modified without affecting the other image segments.

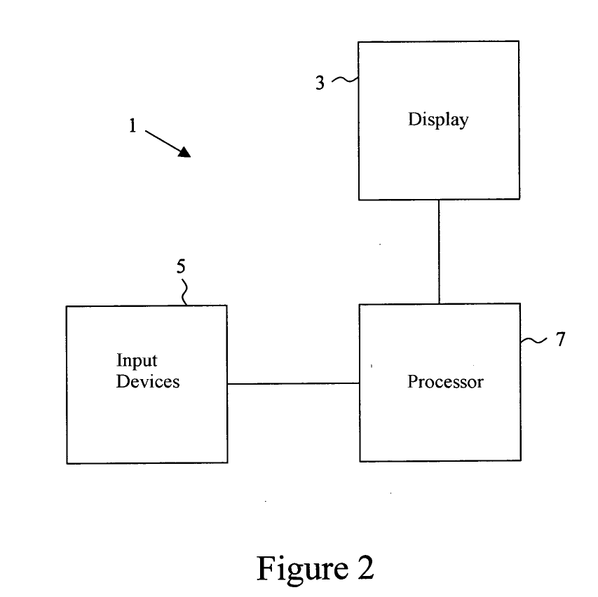

FIG. 2 shows a system allowing a user to view and manipulate a digital image. The system 1 comprises a display 3 in the form of a conventional computer monitor, input devices 5 including a computer keyboard and mouse, and a central processing unit (CPU) 7 connected to the display 3 and the input devices 5. During use, a selected image may be displayed on the display 3 under the control of the CPU 7. The user may then use the input devices 5 to select parts of the image and cause various operation to take place by selecting items from menus and selecting buttons in a user interface. General methods of displaying and manipulating digital images are known to those skilled in the art. The system 1 shown in FIG. 2 may be used to implement the method according to the invention described below.

In order to segment the image 21 shown in FIG. 1 into a background image segment 25, a foreground image segment 23 and an edge image segment 27, a two stage process is carried out. Initially, the image 21 is segmented using a semi-automatic process. Then a refinement process may be carried out manually to minimise any errors that occurred in the automatic segmentation. Using this two stage process, an accurate segmentation of the image 21 is achieved. It is understood, however, that each step may be applied on its own, in the reverse order, or in conjunction with any other suitable segmentation techniques.

In the segmentation method, pixels are assigned to a particular image segment according to their colour so that a pixel having a colour (or other visual characteristic) that is one of a defined set of colours (or visual characteristics) is assigned to a particular image segment. To avoid the problems of prior methods where for example a pixel in the background happens to be the same colour as a foreground pixel an additional condition is imposed where an image segment is required to be a contiguous region of the image.

To avoid the problems of prior methods, where an artificial image is required in which for example the background needs to contain only a limited set of predetermined colours, the semi-automatic process involves manually selecting pixels representative of a region that is to be defined as an image segment. The colours (or other visual characteristics) of these manually selected pixel form a sample which is automatically expanded to derive a final selection of colours (or other visual characteristics) that forms the basis for assigning pixels to an image segment. In essence, the user makes an initial pixel selection and the system 1 derives a segment based on that initial selection. To aid understanding, it is noted that the initial manual pixel selection is in image space (that is an array of pixels forming an image), the automatic deriving of the final selection of colours is in colour space (that is the set of colours in the image) and the final image segmentation is then determined in image space.

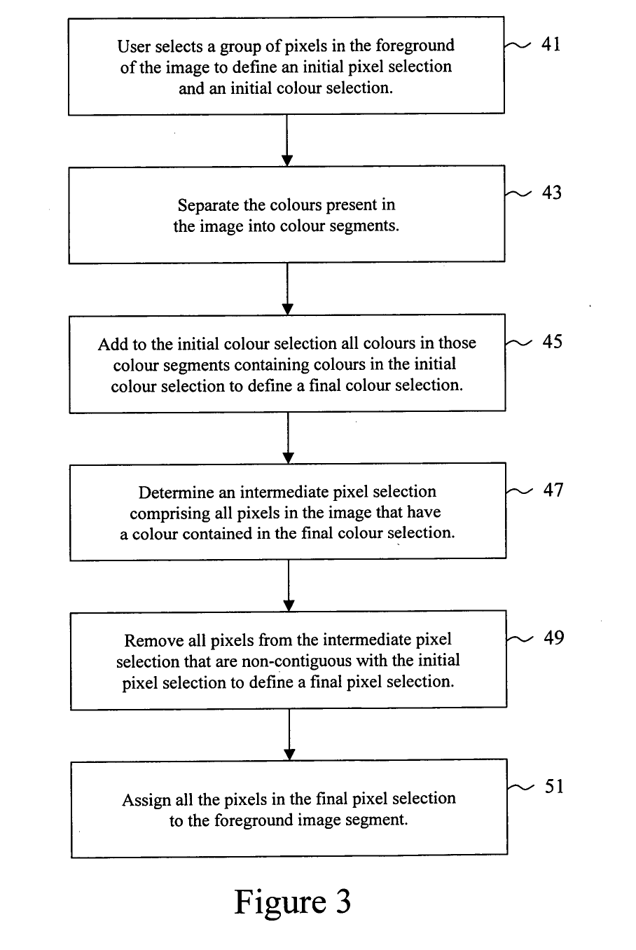

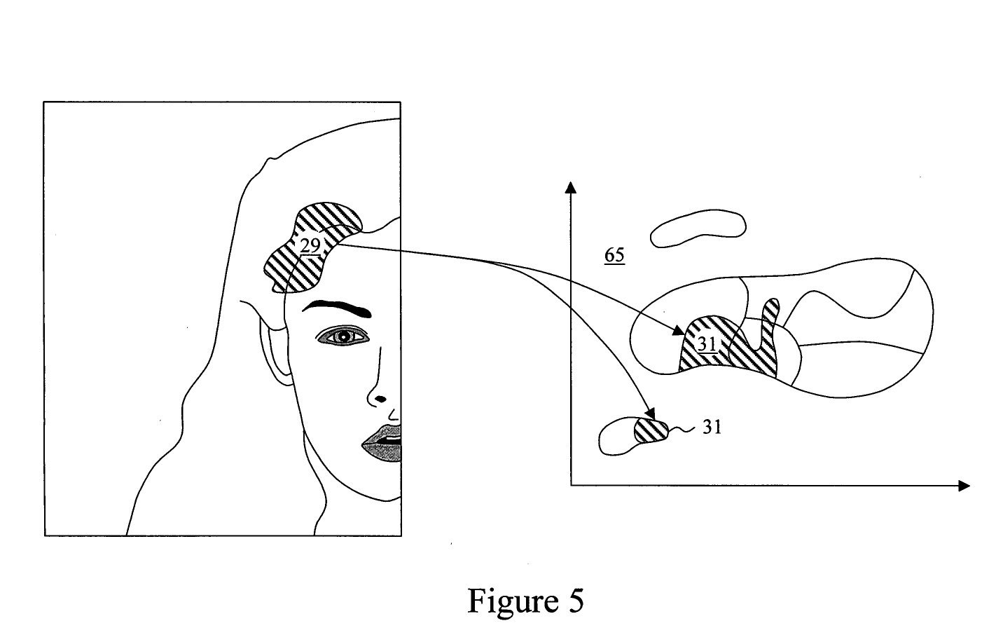

FIG. 3 is a flow diagram of the steps taken to initially segment an image according to the first aspect of the invention. In a first step 41 the user selects (in image space) pixels within a region of the image 21. The selected pixels are those that the user wishes to fall within a particular image segment and will be referred to as the initial pixel selection. For example, the user may wish the face and hair portion of the image 21 to fall within the foreground image segment 23 so the user selects a group of pixels representing the face and hair. One example of an initial pixel selection is shown in the left hand side of FIG. 5 as a shaded region 29. The purpose of this selection is to select pixels whose colours are representative of the colours present in the region of the image 21 to be defined as the foreground image segment 23. The set of colours of the pixels in the initial pixel selection are a sample of the colours present in the foreground portion of the image 21 and may be referred to as the initial colour selection.

The initial pixel selection may be made for example using the system 1 shown in FIG. 2 by selecting an appropriate area of the image 21 or dragging a cursor of predetermined size and shape over the appropriate part of the image 21 displayed on the display 3 using an input device 5 such as a mouse. All the pixels which the cursor moved over while being dragged form the initial pixel selection. In order to aid the user in making the desired initial pixel selection, the size and shape of the cursor may be modified and pixels that have been selected may be highlighted in some way as a visual aid.

In an alternative embodiment, rather that determining an initial colour selection by making an initial pixel selection, instead the initial colour selection may be selected by the user directly from a palette of colours. For example, the user may be presented on the display 3 with a palette of colours which shows all the colours that are present within the image 21 so that the user may make a selection of colours by selecting an area of the palette or by dragging a cursor over the palette in a similar manner as described above. In this embodiment, when the user has selected colours from the palette, all the pixels in the image 21 having any of the selected colours may be highlighted to help the user decide whether the appropriate initial colour selection has been made.

The initial pixel selection made by the user as described above provides an initial colour selection representing colours that are present in the foreground portion of the image 21. However, it is likely that not all colours present in the foreground will be selected since there may be some pixels in the foreground that were not selected by the user and which have colours not included in the initial colour selection. Therefore, although the resulting initial colour selection will be representative of the colours present in the foreground, the initial colour selection is likely to not contain all colours present in the foreground. To overcome this, a process is carried out described in greater detail below whereby the number of the colours in the initial colour selection is automatically increased by the system 1 to obtain a better range of colours that are present in the foreground. This process involves an initial process carried out in colour space as follows.

At a next step 43 the set of all colours that are present within the image 21 are separated into subsets. The subsets may be chosen for example so that in broad terms each subset contains similar colours. Two colours may be considered similar, for example, if the three values that define one of the colours are sufficiently close to the corresponding values defining the other colour. This corresponds to the condition that the two points in colour space representing the two colours are sufficiently close together. However, other methods for separating colours into subsets may be used. For example, in one method the colour space is separated into contiguous regions which may be referred to as colour segments, each colour segment representing a subset of colours. When additional visual characteristics are used or if visual characteristics other than colour are used, then the corresponding contiguous regions in an n-dimensional space may be referred to as characteristic segments. This process of separating colour space into colour segments may be referred to as segmenting colour space. The particular way in which the colour space is segmented may be determined according to any suitable algorithm. For example, one method for segmenting colour space is described in our International patent application published under WO 03/052696 although other methods known to the skilled person could also be used. What is important is that the colour space 65 is separated (i.e. segmented) into one or more contiguous regions which are the colour segments.

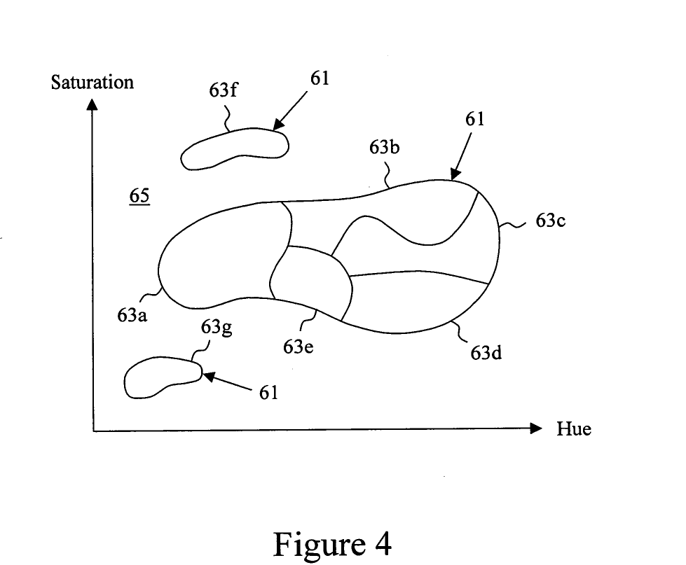

FIG. 4 shows a two dimensional cross-section of the three-dimensional colour space 65 of the image 21 in the plane of hue and saturation. Only two of the three dimensions are shown for ease of visualisation. The set of colours that are present within the image 21 are determined by considering the colour of each pixel in the image 21 in turn. Beginning with an empty set, if a colour of a pixel is not already in the set then the colour is added to the set otherwise the colour is ignored and the next pixel considered. The resulting set of colours may be represented as a region 61 in colour space 65 which is not necessarily contiguous as is the case in FIG. 4. Only a subset of all possible colours may be present in the image 21 so the region 61 does not necessarily cover the whole of the colour space 65 as is again the case in FIG. 4. As a result of the segmentation of colour space 65, the region 61 is separated into several colour segments 63 as shown in FIG. 4. The colour segments 63 form the basis for increasing the colours in the initial colour selection to form the final colour selection.

In a practical system a pixel colour can be one of only a finite number of colours, corresponding to the finite number of combinations of values of the parameters used to define colour. In this case the colour space will be a discrete space which may be visualised most easily as a lattice structure where each point on the lattice corresponds to a particular colour. References herein to regions of colour space may be taken to mean regions of points on the lattice structure. However, for ease of visualisation, FIGS. 4, 5 and 6 have been drawn to show continuous regions. If the number of colours is very large, the discrete colour space will approximate a continuous colour space.

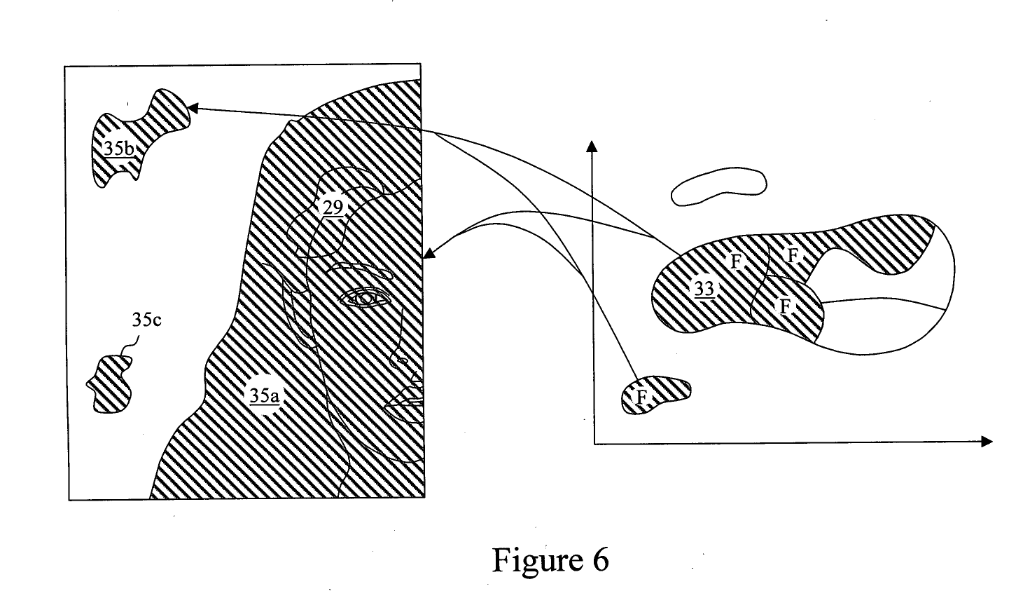

In a next step 45, all colours in those colour segments containing colours in the initial colour selection are added to the initial colour selection to form a final colour selection. On the right hand side of FIG. 5 the colours in the initial colour selection, i.e. the colours of the pixels in the initial pixel selection 29, are shown as a shaded region 31. The resulting final colour selection is shown on the right hand side of FIG. 6 as a shaded region 33 in which the initial colour selection 31 has been expanded to fill those colour segments in which the initial colour selection fall. It can be seen that the final colour selection therefore comprises one or more whole colour segments, the particular colour segments being those containing the colours that were present in the initial colour selection.

Using the method described above a greater range of colours present in the foreground are automatically selected without having to manually select additional colours. At the end of this process the final colour selection will preferably contain a high proportion of the colours present in the foreground portion of the image 21.

In a next step 47, all pixels in the image 21 that have a colour contained in the final colour selection are selected to form an intermediate pixel selection. The resulting pixels in the intermediate pixel selection are shown as a shaded region 35 on the left hand side of FIG. 6 The intermediate pixel selection will comprise the foreground portion of the image. However, the intermediate pixel selection may also comprise pixels that are not in the foreground but which happen to have the same colour as pixels in the foreground as can be seen in FIG. 6 by shaded regions 35b and 35c. To ensure that only foreground pixels are selected, in a next step 49, all pixels in the intermediate pixel selection that are not contiguous with the initial pixel selection 29, such as shaded regions 35b and 35c in FIG. 6, are removed from the intermediate pixel selection resulting in a final pixel selection. In this way, any background pixels which happen to have the same colour as colours present in the foreground will be removed because those background pixels are likely to be non-contiguous with the initial pixel selection.

In the method described above, the final pixel selection was derived from the final colour selection in two separate steps 47, 49. However, these two steps may be carried out in the opposite order or together to achieve the same end result of a final pixel selection. For example, the initial pixel selection 29 may be expanded in a contiguous manner such that only pixels having colours in the final colour selection are included in the expanded pixel selection. When it is no longer possible to expand the initial pixel selection in this way, which would occur when the expanded selection is bounded entirely by pixels having colours not in the final colour selection, the fully expanded initial pixel selection is the final pixel selection.

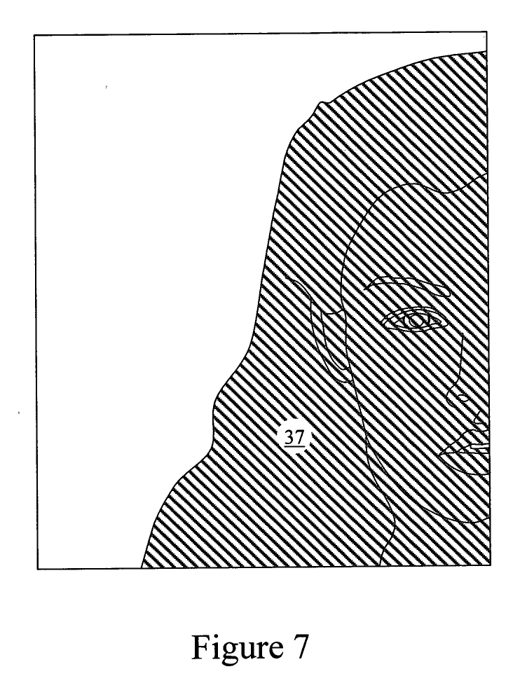

In a next step 51, all pixels in the final pixel selection are assigned to the foreground image segment 23. The shaded region 37 shown in FIG. 7 indicates the final pixel selection and therefore those pixels that have been assigned to the foreground image segment 23.

Using the method described above, a single image segment is defined which consists of the pixels comprised in the final pixel selection and which represents a defined region of the image. The method also involves defining a final colour selection which consists of the set of colours that are likely to be present in the pixels of the defined image segment. If the image segment represents the foreground portion of the image for example, the colours in the final colour selection are those colours that are likely to be present in the foreground portion of the image. The term ‘likely’ is used here since the colours of the final colour selection are derived in an automatic manner from the initial colour selection and therefore there is a chance that some of the colours in the final colour selection will not actually be present in the pixels of the image segment. It can be seen that there is a close association between the image segment and the final colour selection and hence there is also a close association between each colour in the final colour selection and the image segment. The final colour selection and each colour in the final colour selection may therefore be referred to as being assigned to the image segment. In short, a colour is assigned to the image segment if the colour is (likely to be) present in pixels forming the image segment.

The method described above may be repeated a further number of times to define further image segments resulting in a final segmented image. Each time a further image segment is defined using this method, an associated final colour selection is also defined. In each case, all the colours in a particular final colour selection may be assigned to the associated image segment. It is not necessary that every pixel in the image is assigned to an image segment in which case there may be some regions of the image that do not form part of any image segment. Rather, any region of the image which requires modification independently of the other regions should be defined as a separate image segment. If some pixels do not require modification then there is no need for them to form part of an image segment. If it is desired that all pixels in the image 21 are assigned to at least one image segment, then if p image segments need to be defined, p-1 image segments may first be defined using the method described above. Then, all those pixels in the image 21 that have not yet been assigned to an image segment are assigned to the final image segment. For example, if a foreground image segment and a background image segment have been defined. Any pixels not assigned to either the foreground image segment or the background image segment may be assigned to the edge image segment.

When several image segments have been defined, it can be seen that the resulting image segments may not be mutually exclusive in that there may be pixels that have been assigned to two or more different image segments. Similarly, the resulting final colour selections may not be mutually exclusive in that a particular colour may belong to two or more different final colour selections, and therefore be assigned to two or more different image segments. This situation may be desirable in some circumstances, for example if a pixel occurs within a blurred region of an image where the pixel represents a mixture of both the foreground and background. In this case, if for example the tint of the foreground only is changed, the tint of the mixed pixel would also need to be changed. Similarly, if for example the hue of the background only is changed, the hue of the mixed pixel would also need to be changed. In this case, it would be advantageous to assign the mixed pixel to both the foreground 23 and background 25 image segments so that the visual characteristics of the mixed pixel are modified together with either the foreground or the background.

However, it may be desirable to ensure that image segments and/or final colour selections are mutually exclusive. There are several ways to achieve this. For example, in the case where there are two image segments, to ensure that the image segments are mutually exclusive any pixels that have not been assigned to an image segment after the first image segment has been defined are automatically assigned to the remaining image segment. In the case where there are three image segments, such as foreground, background and edge image segments, the following process may be carried out. Initially, the first and second image segments (such as the foreground 23 and background 25 image segments) are defined as in the previous example to obtain two mutually exclusive image segments. Then, the second image segment is eroded by successively removing pixels from the boundary of the second image segment effectively creating a buffer layer between the first and second image segments. The eroded second image segment then becomes the second image segment and those pixels that were removed from the original second image segment in the erosion process are assigned to the third image segment (such as the edge image segment 27).

Another way to ensure that the final colour selections and/or the image segments are mutually exclusive is as follows. Initially, a first image segment is defined in the manner described above by making a first initial pixel selection. This process also involve defining an associated first final colour selection whose constituent colours are assigned to the first image segment. Then, a second image segment and associated second final colour selection are defined in the same way by making a second initial pixel selection. However, to ensure that the first and second final colour selections are mutually exclusive, when the second final colour selection is defined, any colours that have already been assigned to the first final colour selection are not also assigned to the second final colour selection. To ensure that the first and second image segments are mutually exclusive, any pixels that have already been assigned to the first image segment are not also assigned to the second image segment. Each time subsequent image segments and final colour selections are defined, any pixels and/or colours already assigned to a previously defined image segment are not assigned to the new image segment. It can be seen that selectively applying the conditions of final colour selection mutual exclusivity and image segment mutual exclusivity will generate differing results in terms of the final segmentation of the image.

The information relating to the assignment of pixels or colours to image segments may be stored in any suitable manner. For example, a data array may be used comprising an element for each pixel or colour in the image 21 which stores a value indicating which image segment the pixel or colour corresponding to the array element is assigned to. The information relating to the assignment of pixels and colours to image segments, and any other data relating to the segmentation of the image may be included and stored together with the normal image data, for example in the same or associated data file.

The method described above has been describes as a semi-automatic process since a manual initial pixel selection was made by a user in addition to an automatic process to derive the final colour selection. However, it is understood that the initial pixel selection or initial colour selection could also be made automatically making the process fully automatic. Allowing a user to make the initial pixel selection, however, is likely to result in a better segmentation of the image as an element of human judgement is included.

In the method described above, pixels in the image are assigned to one or more of several image segments. However, in a variation to this method, each pixel is labelled or assigned to an image segment according to which colour segment the colour of the pixel belongs to. In other words, every pixel in the image having a colour belonging to a particular colour segment is assigned to the same image segment. This process may be referred to as assigning a pixel to a colour segment. There would thus be a one to one correspondence between the image segments and the colour segments. This method would only require the step 43 of FIG. 3 to be carried out and none of the other steps in FIG. 3. This variation may be regarded as a kind of intermediate or incomplete image segmentation allowing full segmentation of the image to be carried out later. For example, an image 21 may be provided with information relating to the assignment of pixels to colour segments already included. In this way, the semi-automatic image segmentation described above could be carried out without having to perform the process of segmenting colour space into colour segments. In this case, when the initial pixel selection has been made the intermediate pixel selection is derived by determining all those pixels in the image that are assigned to colour segments that pixels in the initial pixel selection have been assigned to.

Although the method according to the first aspect of the present invention provides a fast and efficient means for segmenting an image 21, there may be some circumstances when pixels are assigned to the wrong image segment. This may be the case, for example, where the boundary between the foreground and background is soft or blurred. Where a first colour present in a first portion of an image 21 is very similar to a second colour present in a second portion of the image 21, the first colour may be assigned to the wrong image segment resulting in wrongly assigned pixels.

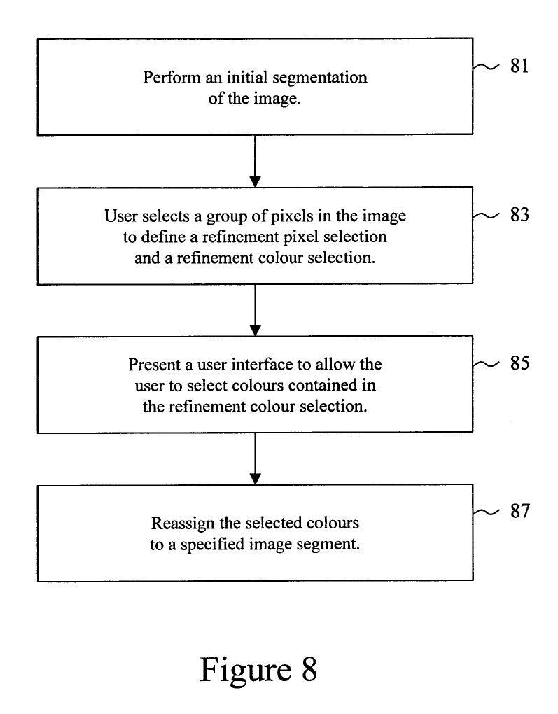

FIG. 8 is a flow diagram of a method to refine the segmentation of an image 21 according to the second aspect of the present invention. In a first step 81 an initial segmentation of the image 21 is carried out. This initial segmentation may be performed using the method described above or any other suitable method. After the initial segmentation pixels have been assigned to one or more image segments such as the background image segment 25, the foreground image segment 23 and the edge image segment 27.

In performing the initial image segmentation some pixels may have been wrongly assigned to an image segment, wrongly excluded from an image segment or assigned to the wrong image segment. It is desirable therefore to refine the assignment of pixels to image segments to achieve a more accurate segmentation of the image 21. This could be achieved by the user manually selecting and reassigning wrongly assigned pixels. However, this process is laborious and time consuming. Since a pixel is assigned to a particular image segment based, among other things, on its colour, and in particular on which image segment the colour of the pixel is assigned to, an alternative way to reassign pixels to image segments is to modify the assignment of colours to image segments. This method is advantageous since there may be many pixels having the same colour, so modifying the assignment to particular image segments of that colour will affect the assignment to particular image segments of several pixels at once. This results in faster and more efficient refinement of the image segmentation.

Modifying the assignment of colours to particular image segments is equivalent to modifying the colours contained in the final colour selections by adding or removing colours from the final colour selections. A colour is assigned to a particular image segment by virtue of the particular final colour selection to which it belongs. Therefore, adding or removing a colour to or from a particular final colour selection will have the effect of assigning or unassigning that colour to or from the associated image segment.

To refine the image segmentation, the assignment of colours to image segments may be modified so that a colour wrongly assigned to an image segment may be unassigned from that image segment, and if necessary, correctly reassigned to a different image segment. The assignment of pixels to image segments may then be refined on the basis of the refinement of colours assignments. A colour not assigned to any image segment may also be assigned to an image segment. In a next step 83, using the system 1 shown in FIG. 2, the user selects a group of pixels in the image having colours for which the assignment to particular image segments needs to be refined. For example, in the image shown in FIG. 1, the colours of pixels of the hair at the boundary between the foreground and the background may have been wrongly assigned to the background image segment 25. Accordingly, in this case the user selects a group of pixels at the boundary between the hair and the background. The selection of pixels may be made by dragging a cursor over the image in a manner described above. The resulting group of selected pixels may be referred to as a refinement pixel selection and the colours of the pixels in the refinement pixel selection may be referred to as a refinement colour selection. In a similar way as with the initial segmentation process, the refinement colour selection may also be defined by selecting colours from a palette.

In one embodiment where the final colour selections or image segments are not required to be mutually exclusive, the overlap between image segments or final colour selections may be used to provide an indication of those colours which are most likely to require refinement. In particular, the refinement pixel selection may comprise all those colours which have been assigned to more than one image segment, or those colours of those pixels that have been assigned to more than one image segment. Overlap between image segments is likely to occur mainly at the boundary between image segments which is where wrong assignment of pixels and colours to image segments is most likely to occur. In this way, an automatic means to derive a refinement pixel selection is provided.

The colours present in the refinement colour selection are a subset of all the colours present in the image 21. In particular, the colours in the refinement colour selection are those colours which require more detailed attention with regard to their assignment to particular image segments.

In a next step 85 a user interface displayed on the display 3 is used to display the colours of the refinement colour selection to the user to allow the user to manually modify the assignment of colours to image segments. Only those colours contained in the refinement colour selection are displayed. This feature is advantageous as it allows the user to concentrate on the important colours in the refinement process without being distracted by the other less important colours. Once the assignment of colours to image segments has been refined, the assignment of pixels to image segments may be performed on the basis of the refinement of the assignment of colours to image segments. For example, the initial segmentation method described above may be repeated using the refined assignment of colours to image segments as the basis for determining the final colour selections for each image segment. Alternatively, the reassignment of pixels to image segments may be performed selectively so that, for example, only those pixels in the refinement pixel selection, or some other user defined selection, are affected by the refinement process.

Several specific user interfaces will now be described, which may be implemented on the system 1 shown in FIG. 2, although it is understood that other suitable interfaces could be used.

In a first type of interface, the colours in the refinement colour selection are displayed using a tree structure comprising several display levels, each level corresponding to one of the parameters used to define the visual characteristics of pixels, which may be hue, lightness or saturation for example. At the first level of the tree structure, several nodes are displayed to the user where each node represents a subset of the colours in the refinement colour selection. In particular, each node represents all colours in the refinement colour selection having the same value of a first parameter used to define the visual characteristics of pixels. The colours represented by a particular node in the first level of the tree structure are divided into further subsets which are represented by a further set of nodes displayed to the user in a second display level of the tree structure. The colours represented by the other nodes in the first level may be similarly divided into further subsets and represented by further nodes in the second level. Each node in the second level represents colours having the same value of a second parameter used to define the visual characteristics of pixels. The tree structure comprises further levels, each successive level comprising nodes that represent subsets of the colours represented by nodes in the level above. In this way, as one moves down successive levels of the tree structure, successively smaller subsets of the colours in the refinement colour selection are represented by nodes. At the lowest level of the tree structure, each node represents individual colours.

The user interface is arranged so that, in a next step 87 shown in FIG. 8, the user can select a node to enable the colours represented by the selected node to be assigned, unassigned or reassigned to or from any desired image segment. One advantage of using a tree structure as described above is that many colours may be reassigned simultaneously since most nodes represent several colours that have been grouped together in a convenient manner. However, if desired, reassignment of individual colours is possible at the lowest level of the tree structure. Not all levels of the tree structure need to be displayed at once. This provides the advantage that a user can focus on a particular subset of colours without being distracted by the other colours which do not require reassignment.

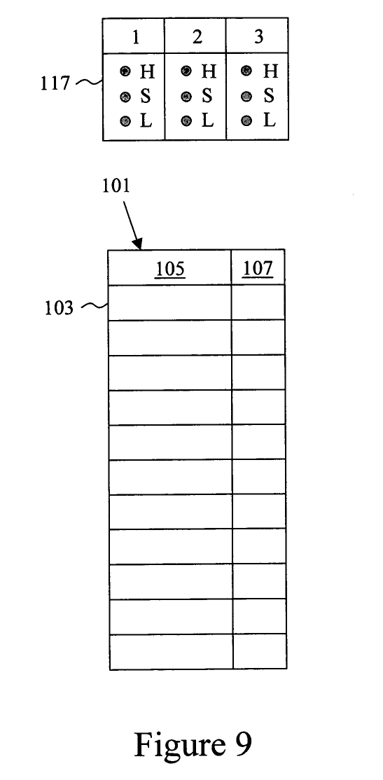

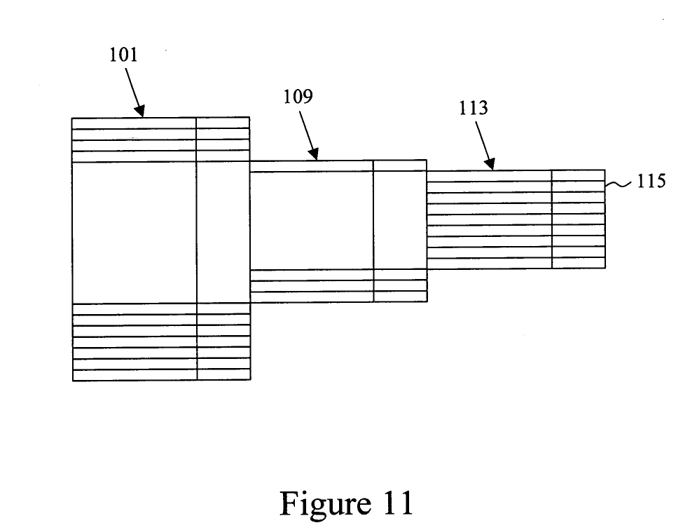

FIGS. 9, 10 and 11 show one possible user interface using a tree structure. In this example mutual exclusivity exists between final colour selections so that each colour is assigned to one image segment at most, although this is not necessary when using this interface. Initially, as shown in FIG. 9, a first column 101 is presented to the user which corresponds to a first one of the three parameters, which in this example is the lightness parameter. The first column 101 corresponds to the first display level of the tree structure described above. The first column 101 contains one or more rows 103 where each row 103 represents a subset of the colours in the refinement colour selection and corresponds to a node in the tree structure. In this example the first column 101 corresponds to the lightness parameter so each row 103 of the first column represents all colours in the refinement colour selection having the same lightness value.

Each row 103 may conveniently display the lightness value represented by the row 103 in a first display area 105 on the row 103. Alternatively or additionally, each row 103 could be shaded to indicate the lightness value associated with the row 103 so that a row 103 representing a high lightness value could be lightly shaded while a row 103 representing a low lightness value could be darkly shaded. Each row 103 may also conveniently display the number of colours represented by the row 103 in a second display area 107 on the row 103. Each row 103 may also indicate the image segment to which the colours represented by the row 103 have been assigned. If the colours represented by a row 103 have been assigned to several image segments, this information may also be displayed. For visual convenience, the rows 103 in the first column 101 may be arranged in order of the lightness value. In order to eliminate redundant rows and aid visualisation, if there are no colours in the refinement colour selection having a particular lightness value, no row is displayed in the first column 101 for that particular value. As a further means to make the display more compact, where there are a large number of lightness values, each row 103 may represent several different lightness values, thereby reducing the total number of rows displayed. In one embodiment, the user is able to specify a scaling factor which determines the number of different values represented by each row 103 and which may be modified during the refinement process.

In order to assign, unassign or reassign the colours represented by one or more rows 103 to or from a particular image segment the user may select the desired rows 103 and cause the colours to be assigned, unassigned or reassigned. For example, the user may use a mouse to click on the first display area 105 causing a pull down menu to appear from which several image segments, such as background, foreground and edge, may be selected. When an image segment is selected from the menu, the colours represented by the selected rows 103 are assigned or reassigned to that image segment.

The interface may be provided with a feature in which one or more colours can be assigned a undecided status. The pixels in the image 21 having colours that are of undecided status may be highlighted in the image 21 to allow the user to see whether those colours are the ones requiring reassignment before actually making an assignment.

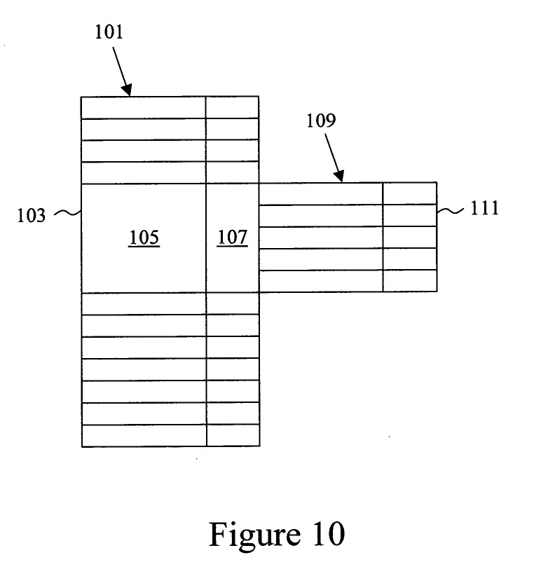

In order to view the lower display levels of the tree structure and thereby reassign smaller subsets of colours the user may select a particular row 103 of the first column 101 and cause a second column 109 to be displayed besides it as shown in FIG. 10. The selection may be made for example by clicking on the second display area 107 of a row 103 in the first column 101. The second column 109 represents the second of the three parameters, which in this case is hue, and corresponds to the second display level of the tree structure. The second column 109 is divided into rows 111, corresponding to nodes in the second level of the tree structure, each one representing a subset of the colours represented by the selected row 103 of the first column 101. In this example the second column 109 corresponds to the hue parameter so each row 111 of the second column 109 represents colours having the same hue value. Since these colours are a subset of the colours represented by the single selected row 103 of the first column 101, these colours also all have the same lightness value.

In the second column 109, the rows 111 and associated information such as the number of colours and hue value represented by each row 111 may be displayed in the same manner as the rows 103 of the first column 101. Again, any redundant rows are not displayed. When the second column 109 is displayed, the selected row 103 of the first column 101 may be expanded vertically so that it has a height equal to the height of the second column 109. This provides the user with a visual indication that the second column 109 has been displayed as a result of selecting the expanded row 103. To compensate for the expansion of the selected row 103, the other rows 103 of the first column 101 may be contracted vertically. Alternatively, when the second column 109 is displayed, the first column 101 may be made to disappear.

The user may select one or more rows 111 of the second column 109 and reassign the colours represented by the selected rows 111 in the same manner as for the first column 101.

In the same way as with the first column 101, a row 111 of the second column 109 may be selected to cause a third column 113 to be displayed besides the second column 109. The third column 113 corresponds to the third of the three parameters which in this case is saturation. The third column 113 is divided into rows as before which correspond to nodes of the third display level of the tree structure. Each row of the third column 113 represents a subset of the colours represented by the selected row 111 in the second column 109, the subset being those colours having the same saturation value. Since the colours represented by the selected row 111 have the same lightness and hue values, each row in the third column 113 represents colours having the same lightness, hue and saturation values. Since there are only three parameters in this example, each row of the third column therefore represents an individual colour (being uniquely defined by its lightness, hue and saturation values). One or more rows may then be selected as described above to reassign the colour represented by the selected row to a different image segment.

In order to return to higher levels of the tree structure, the user may select a particular column to cause the columns that represent lower levels of the tree structure than it to disappear. Other row selections may then be made. In this way, the user may assign or reassign colours within whole range of colours present in the refinement colour selection by navigating through the tree structure and assigning or reassigning groups of colours or individual colours. The parameters represented by each column may be changed using a separate menu 117 so that the most suitable grouping of colours in the tree structure may be chosen. In the menu 117, a series of buttons is provided for each column, where each button corresponds to a different parameter. By selecting the appropriate buttons, the parameter represented by each column may be selected so that, for example, the first column corresponds to saturation, the second column corresponds to lightness and the third column corresponds to hue.

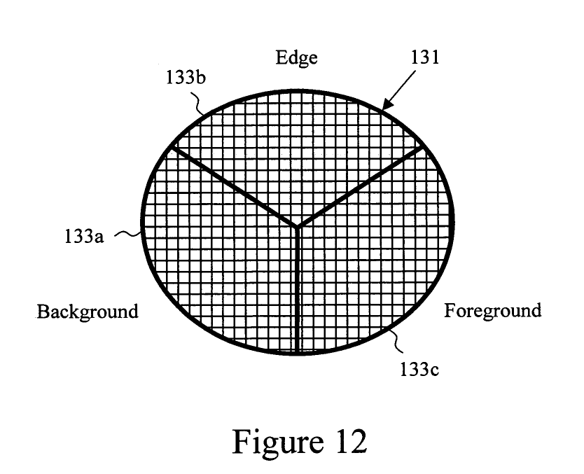

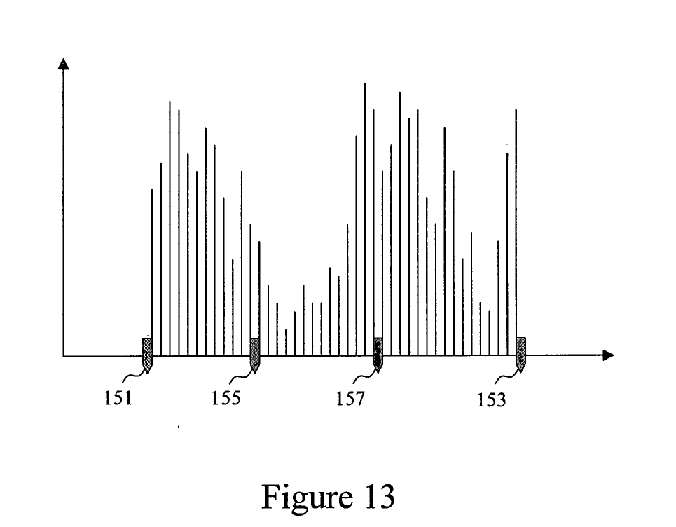

Two further user interfaces are shown in FIGS. 12 and 13. In FIG. 12 a circular display 131 is presented which is split into three portions 133a, 133b, 133c, each portion 133 representing one of three possible image segments, foreground, background and edge. Each colour present in the refinement colour selection is displayed in the portion 133 corresponding to the image segment the colour is assigned to. For example, each portion 133 may be divided into several small regions, each one representing a colour which may be indicated by colouring the region according to the colour it represents. The position of the region representing a colour within a portion may be determined by the values of the parameters representing the colour. For example, colours having a low value of a first parameter such as hue may be located towards the centre of the circular display 131 while colours having a high value of the first parameter may be located towards the edge of the display 131. Similarly, the circumferential position of a colour may be determined by the value of the second parameter such as saturation. The reassignment of one or more colours may be made by selecting individual or multiple colours from within the display 131 and dragging those colours to a different portion 133 of the display 131. Alternatively, the user may move the boundaries between the portions 133 to move colours from one portion 133 to another.

In FIG. 13, a histogram of the colours present in the refinement colour selection is presented to the user. The horizontal axis of the histogram represent the value of a particular colour parameter and the vertical axis represents the frequency of colours having particular values of the parameter represented by the horizontal axis. Located on the horizontal axis are two fixed markers, 151, 153 and two sliders, 155, 157, which may be moved in a horizontal direction along the horizontal axis. The two markers 151, 152 and two sliders, 155, 157 define three ranges of values on the horizontal axis which defines the image segment to which the colours are assigned. By moving the sliders, 155, 157, a user may cause colours to be moved from one image segment to another.

In the user interfaces described above, the assignment and reassignment of colours to image segments was performed by selecting colours or groups of colours in the tree structured interface shown in FIGS. 9, 10 and 11, the circular display shown in FIG. 12 or the histogram shown in FIG. 13. In other embodiments, the selection of colours for the purpose of assigning or reassigning those colours to particular image segments may be made by directly selecting colours from the image 21. For example, the user may select one or more pixels in the image and the colours of those selected pixels may be assigned or reassigned to a specified image segment.

When an image has been segmented using the methods described above, it can still occur that pixels are wrongly assigned to particular image segments, or are not assigned to any image segment at all. For example, it may occur that an isolated group of pixels occurring the background portion of the image 21 were not assigned to the background image segment because of the colour of the pixels for instance, and were instead assigned to some other image segment or assigned to no image segment at all. In such cases, it may happen that all the pixels in the vicinity of the wrongly assigned pixels have been assigned to the correct image segment so that their assignment to image segments does not require modification.

To eliminate such errors, a facility may be provided in which a user may select pixels in a region of the image 21 using a cursor or dragging tool for example. Then the user may specify that only those selected pixels that have already been assigned to one or more specified image segments, or which have not been assigned to any image segment, are reassigned or assigned to a desired image segment. For example, a region of the image 21 may be selected containing pixels that obviously belong to the background portion of the image but which have not been assigned to any image segment due to errors of assignment. Then, the user specifies that any of the selected pixels which have not yet been assigned to an image segment should be assigned to the background image segment. The assignment of any of the other selected pixels remains unchanged. Using the same technique, all pixels in a selected region of the image that have already been assigned to the edge image segment 27 may be selectively reassigned to the background image segment 25 without affecting the assignment of the other pixels. To achieve this, a menu may be provided which allows the user to specify a first image segment (which includes specifying no image segment) and to specify a second image segment (which includes specifying no image segment). Then, pixels in the selection that are already assigned to the first specified image segment (including the possibility of being assigned to no image segment) are reassigned to the second specified image segment (including the possibility of being reassigned to no image segment) without affecting any other pixels in the selection.

It is understood that the automatic segmentation method and the manual segmentation method described above may be used separately, in the reverse order or in conjunction with any other suitable segmentation methods. When used in reverse order for example, the manual method may be first used to specifically assign certain colours to a particular image segment, the colours being those that the user expects would likely be wrongly assigned using an automatic or semi-automatic process. Then, the automatic method may be used to segment the image 21 but where the previous manual assignment of specific colours overrides any automatic assignment of those colours, that is, any assignment of colours performed in the manual assignment is not affected by the subsequent automatic assignment.

In another possibility, the combination of the semi-automatic method and the manual refinement method may be applied to a portion of an image 21. This would provide an accurate assignment of colours to particular image segments. Then, this particular assignment of colours could be applied selectively to other portions of the image 21, for example by dragging a cursor over selected portions of the image 21. Any pixels that the cursor passes over while being dragged would be assigned to particular image segments according to the colour assignments previously determined. Any other pixels would not be assigned, or assigned using a different method.

When an image 21 has been segmented, any suitable operation may be carried out on the pixels belonging to one or more selected image segments. For example, the foreground portion of the image may be overlaid onto a new background or the colour or texture of the background only may be modified. This may be achieved by performing the appropriate image processing only to those pixels which have been assigned to a specified image segment. Many further possibilities will readily occur to the skilled person.

What is claimed is:

1. A method for segmenting a digital image into image segments, the digital image comprising a plurality of pixels, each pixel having a set of n values defining the visual characteristics of each pixel, each possible set of n values being representable as a point in an n-dimensional space, the n-dimensional space being divided into two or more contiguous characteristic segments, where the sets of n values are the co-ordinates of the points in the n-dimensional space, the method comprising the steps of:
selecting one or more pixels in the image to define an initial pixel selection;
determining a final pixel selection comprising those pixels in the image that are contiguous with the initial pixel selection and that have sets of n values corresponding to points in the n-dimensional space in the same characteristic segments as those points corresponding to the sets of n values of pixels in the initial selection; and
assigning the pixels of the final pixel selection to a first image segment;
whereby the visual characteristics of the pixels of the first image segment may be modified independently of other pixels.

2. The method of claim 1 in which the set of n values includes at least one value defining the colour of a pixel.

3. The method of claim 2 in which the set of n values includes three values defining the colour of a pixel.

4. The method of claim 3 in which the three values defining the colour of a pixel define the hue, lightness and saturation of a pixel.

5. The method of claim 3 in which the three values defining the colour of a pixel define the red, green and blue components of the colour of a pixel.

6. The method according to claim 1 in which the set of n values includes at least one value defining the texture of the image at a pixel.

7. The method according to claim 1 in which the first image segment is one of a background image segment, a foreground image segment or an edge image segment.

8. The method according to claim 1 comprising the further step of defining a second image segment consisting of all pixels in the image that have not been assigned to the first image segment.

9. The method according to claim 1 in which the step of selecting one or more pixels to define an initial pixel selection is made by a user.

10. The method according to claim 9 in which the user selects pixels directly from the image using a cursor.

11. The method according to claim 9 in which the step of selecting one or more pixels to define an initial pixel selection comprises the further steps of the user selecting one or more sets of n values of the visual characteristics from a palette; and determining those pixels in the image having the selected sets of n values of the visual characteristics.

12. A method for segmenting a digital image, the digital image comprising a plurality of pixels, each pixel having an set of n values defining the visual characteristics of each pixel, the method comprising the steps of:
selecting one or more pixels in the image to define a pixel selection;
determining the different sets of n values that are present in the pixel selection;
presenting a user interface comprising selectable portions each selectable portion corresponding to one or more different sets of n values present in the pixel selection; and
selecting one or more selectable portions of the user interface to assign one or more particular sets of n values to an image segment;
whereby the visual characteristics of the pixels of the image segment may be modified independently of other pixels.

13. The method of claim 12 in which the set of n values includes at least one value defining the colour of a pixel.

14. The method of claim 13 in which the set of n values includes three values defining the colour of a pixel.

15. The method of claim 14 in which the three values defining the colour of a pixel define the hue, lightness and saturation of a pixel.

16. The method of claim 14 in which the three values defining the colour of a pixel define the red, green and blue components of the colour of a pixel.

17. The method of claim 12 in which the set of n values includes at least one value defining the texture of the image at a pixel.

18. The method of claim 12 in which the selectable elements are presented in a tree structure comprising nodes arranged in levels, each level of the tree structure corresponding to a visual characteristic, and each node in a level corresponding to a value or range of values of the visual characteristic.

19. The method of claim 18 in which only a subset of the nodes are presented to the user at a time.

20. The method of claim 18 in which the correspondence between the levels of the tree structure and the visual characteristics may be modified.

21. The method of claim 12 in which the step of selecting one or more pixels in the image to define an initial pixel selection is performed by a user.

22. The method according to claim 21 in which the user selects pixels directly from the image using a cursor.

23. A method for segmenting a digital image to define a first image segment, the digital image comprising a plurality of pixels, each pixel having a set of n values defining the visual characteristics of each pixel, each possible set of n values being representable as a point in an n-dimensional space, the n-dimensional space being divided into two or more contiguous characteristic segments, where the sets of n values are the co-ordinates of the points in the n-dimensional space, the method comprising the step of assigning pixels having sets of n values corresponding to points in one of the characteristic segments to the first image segment.

24. A computer program product comprising computer executable instruction which when run on a computer causes the computer to undertake a method for segmenting a digital image to define a first image segment, the digital image comprising a plurality of pixels, each pixel having a set of n values defining the visual characteristics of each pixel, each possible set of n values being representable as a point in an n-dimensional space, the n-dimensional space being divided into two or more contiguous characteristic segments, where the sets of n values are the co-ordinates of the points in the n-dimensional space, the method comprising the step of assigning pixels having sets of n values corresponding to points in one of the characteristic segments to the first image segment.
